(19) United States
(12) Patent Application Publication
(10) Pub. No.: US 2007/0132548 A1
(43) Pub. Date: Jun. 14, 2007

(54) METHOD AND APPARATUS FOR PROGRAMMING ELECTRONIC SECURITY TOKEN

(75) Inventors: Benjamin Baraz, Tel Aviv (IL); Menachem Diamantstein, Tel Aviv (IL); Yona Newman, Tel Aviv (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/424,620

(22) Filed: Jun. 16, 2006

(30) Foreign Application Priority Data
Dec. 17, 2003 (GB) GB0329176.2
Aug. 4, 2004 (EP) PCT/EP04/51717

(51) Int. Cl. G05B 19/00

(52) U.S. Cl. 340/5.6

(57) ABSTRACT

A method of programming a second security token using data stored on a first security token, wherein a privilege to be assigned to the second security token is selected by a user of the first security token. The user selects from privileges derived from a first set of privileges assigned the first security token. A file containing a definition of the privilege to be assigned to the second security token is transferred from an apparatus for programming security tokens to the second security token.

### FIELD OF THE INVENTION

The present invention relates to electronic security tokens and method of operating thereof, in general, and in particular, to apparatus and a method of programming electronic security token. The invention is applicable to, but not limited to, improving assigning privileges to a Smartcard.

### BACKGROUND OF THE INVENTION

Developments in computer and communication technology have resulted in new devices known as electronic security tokens. One of the most popular electronic security tokens is a Smartcard. Smartcards are used in a wide variety of applications. Containing embedded processors, storage and computational elements, they are used as data storage (for example for storing biometric data, social security information or user profile information) and very widely in electronic ticketing, time systems and access control. There are hundreds of applications of Smartcards and all of them are based on the fact that the information stored in the card itself and communication between the card and other device is protected. These features led to application of these devices as electronic purses used for payments in shops, public transport, road tolling, parking, etc.

Smartcards can communicate with other devices known as card readers and this communication can be established by means of physical connection between electric contacts on the Smartcard and on the reader. There are also known Smartcards which are equipped with wireless communication interface to the reader.

Data storage Smartcards have memory. The type of memory used in Smartcards varies. In some applications it is a random access memory (RAM) and/or an electrically erasable programmable read-only memory (EEPROM). The EEPROM memory is used for applications such as “electronic-money”. It could be also a read-only memory (ROM), which is used to store personal data.

The electronic security token (e.g. Smartcard) contains information on authorizations that have been given to the owner of the particular security token. To use one of the privileges the user of the security token must be first identified that he (or she) is actually the person he (or she) claims to be. There are known mechanisms for identification of the user of the security token. For example if we are using a bank card in a Automated Teller Machine (ATM) the first step is to enter the PIN number. If the entered PIN is correct the ATM presents us the list of actions that we can perform—these are the privileges assigned to the security token (or actually to the legitimate user of this token).

The user privileges assigned to such a token are normally for the exclusive use of a specified user. If further tokens are required with a similar set of privileges or a sub-set, then these must be issued by some suitable authorising third party body which manages and certifies each of the users.

In many situations involving the third party to assign the privilege to another security token, this procedure takes too much time and is expensive.

### SUMMARY OF THE INVENTION

There is a need for a method and an apparatus for programming an electronic security token, which alleviates or overcomes the disadvantages of the prior art.

According to a first aspect of the present invention there is provided a method of programming an electronic security token as claimed in claim 1.

According to a second aspect of the present invention there is provided an apparatus for programming an electronic security token as claimed in claim 14.

According to a third aspect of the present invention there is provided an electronic security token as claimed in claim 33.

The present invention beneficially allows for:
easy and quick programming security tokens without necessity of involving third party, while still maintaining high security level;
complete traceability of performed operations;
delegation of a sub-set of user privileges;
copying or cloning a set of user privileges;
creating new user privileges.

### BRIEF DESCRIPTION OF THE DRAWINGS

The present invention will be understood and appreciated more fully from the following detailed description taken in conjunction with the drawings in which:

FIG. 1 is a flow chart illustrating a method of programming of an electronic security token in a first embodiment of the present invention;

FIG. 2 is a flow chart illustrating steps of a method of programming of an electronic security token performed in a second embodiment of the present invention;

FIG. 3 is a flow chart illustrating steps of a method of programming of an electronic security token performed in a second embodiment of the present invention;

FIG. 4 is a flow chart illustrating a method of programming of an electronic security token in a second embodiment of the present invention;

FIG. 5 is a block diagram of an apparatus for programming a security token in one embodiment of the present invention;

FIG. 6 is a block diagram of an electronic security token in one embodiment of the present invention;

FIG. 7 is a schematic illustration of a method of programming of an electronic security token in one embodiment of the present invention;

FIG. 8 is a schematic illustration of a method of programming of an electronic security token in one embodiment of the present invention.

FIG. 9 shows the privilege data field structure in the first and second security tokens before transfer of privilege information in accordance with one embodiment of the present invention;

FIG. 10 shows the privilege data field structure in the first and second security tokens after the transfer of one set of privilege information in accordance with one embodiment of the present invention.

### DESCRIPTION OF AN EMBODIMENT OF THE INVENTION

The term Service Provider (SP) herein below refers to a entity that provides, registers or controls access privileges to resources, wherein said resources can be accessed based on privileges granted and assigned to security tokens.

Specific examples of SPs include Certification Authorities (CAs) that assure and qualify certificates, and Registration Authorities (RAs) that manage black lists—that is lists of old, rejected or cancelled certificates.

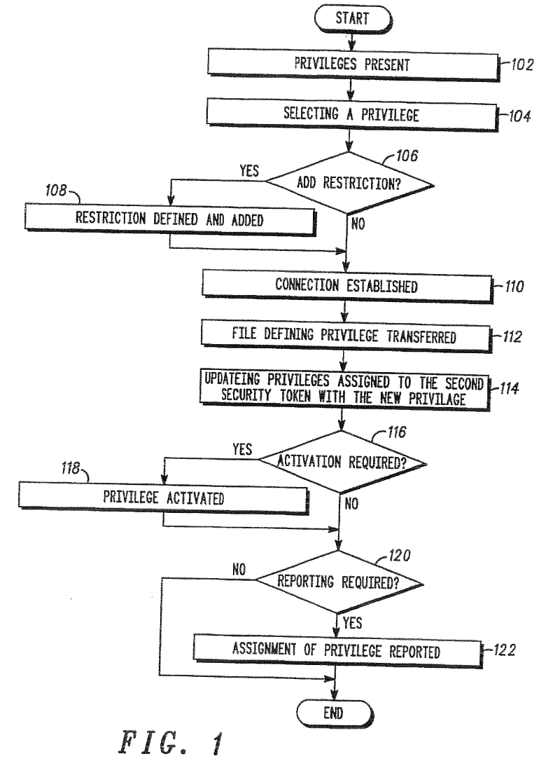

Referring to FIG. 1 and FIG. 5 one embodiment of a method of programming of an electronic security token according to the present invention is shown. Programming (e.g. assigning a privilege) of an electronic security token (later on referred to as “first security token”) requires observing some defined security rules. First the new privilege assigned to a security token cannot be freely chosen. In one embodiment of the present invention a second security token is programmed by assigning a privilege which was derived from a first set of privileges assigned to a first security token. The term derived above and below in the description means that the privilege to be assigned to the second security token can be one of the privileges assigned to the first security token and can also be a privilege which was created especially for the purpose of the assignment to the second security token. However in the latter case creation of such privilege, which is not assigned to the first security token must be allowed by another privilege, which is assigned to the first security token.

In operation, the first security token is connected to an apparatus 500 for programming security tokens and said apparatus 500 is connected by means of computer and/or communication network 540 to a second apparatus for programming security tokens. A second security token is connected to the second apparatus for programming security tokens.

To transfer a privilege a legitimate user of a first security token selects 104 the privilege from a set of privileges that was presented 102 to him/her in a form of a list on a screen of a user interface 510.

The user interface consists at least of a display and a means for entering data, e.g. keyboard or keypad. It is clear for one skilled in the art that other devices for data entry can be similarly used.

After selecting the privilege the user may define restrictions 106, 108 of the privilege. These restrictions may limit time of validity of the privilege on the second security token or define maximum number of times the privilege can be transferred or used after transfer. For security tokens which are part of an access control system the restriction may limit the type and number of resources that can be accessed by the user of the second security token. For security tokens that are used as bank and/or credit cards the restrictions may define other money limits available to the user of the second security token. In one embodiment when the privilege has been assigned to the second security token the privilege is removed from the first set of privileges assigned to the first security token. There are also possible other restrictions of privileges that depend on specifics of a particular security token or privilege type.

When the privilege (or privileges as the same applies to situation when more than one privilege is selected for assignment at a time) is selected, a secure connection is established between the first apparatus for programming security tokens 500 and the second apparatus for programming security tokens. There are known art methods and protocols of data transfers in a computer and communication networks that allow for secure transfer of data. One such protocol is Secure Socket Layer (SSL). It is clear for those skilled in the art that other methods and protocols can be used to ensure security of the connection.

In the next step a definition of the selected privilege (or privileges) in a form of a computer readable file is transferred 112 from the first security token to the second security token.

When the file is received at the second apparatus for programming security tokens a second set of privileges that is assigned to the second security token is updated 114 with the privilege that is defined in the received file.

It is important to know that by assigning the privilege to the second security token identities of user of the first and second security token are still maintained separate and will be accordingly notified in all transactions.

Depending on security regulations of a Service Provider (SP) after updating the second set of privileges the newly assigned privilege may have to be activated 116, 118 before its first use. The assignment of a new privilege may also be reported 120, 122 to the Service Provider.

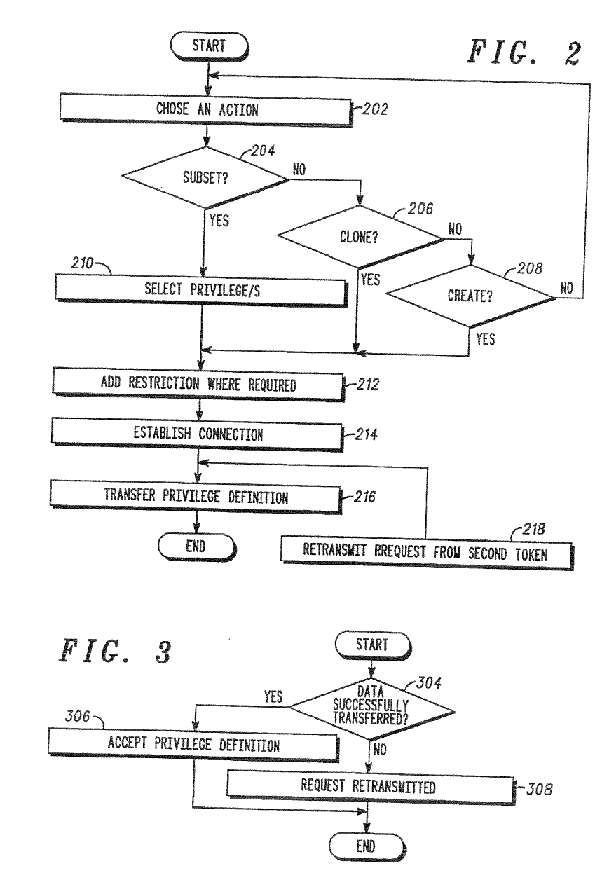

Referring to FIG.2 and FIG. 5 an alternative embodiment of the present invention is shown. As in the first embodiment the first security token is connected to an apparatus 500 for programming security tokens and said apparatus 500 is connected by means of computer and/or communication network 540 to a second apparatus for programming security tokens. A second security token is connected to the second apparatus for programming security tokens.

In the first step the user interface 510 presents 202 to a user of the first security token a list of available actions related to programming of the second security token. The user can choose from:
a) developing a subset 204, 210 of privileges that will be assigned to the second security token;
b) cloning 206 the first set of privileges and assigning this first set to the second security token;
c) creating 208 a new privilege, wherein creation of such new privilege, which is not assigned to the first security token must be allowed by another privilege, which is assigned to the first security token.

In the next step the user may define restrictions 212 that will limit the use of the privileges while used by a user of the second security token.

After establishing a secure connection 214 between the first apparatus for programming security tokens 500 and the second apparatus for programming security tokens a computer readable file containing definition of a privilege (or privileges) is transferred to the second apparatus for programming security tokens.

Referring to FIG. 3 and FIG. 2 the second apparatus for programming security tokens checks the received file containing the definition of the privilege for errors 304. If the file was received correctly the privilege definition is accepted 306 by the second apparatus for programming security tokens. If an error occurred and the received file is corrupted the second apparatus for programming security tokens requests 308, 218 repeating of the transfer of the file. In one embodiment the method used for detecting errors in the received file is a Cyclic Redundant Check (CRC) method. In another embodiment a checksum method can be used.

It is clear for those skilled in the art that other methods of detecting errors which occurred during the transfer process can be successfully used.

With reference to FIG. 4 a process of activation of the new privilege is explained. When the file with definition of the privilege is accepted after receiving without error by the second apparatus for programming security tokens it is reported 402 to the Service Provider. The Service Provider validates 404 the privilege and generates creation parameters. In the next step the creation parameters are transmitted 406 to the second apparatus for programming security tokens. Finally, using the privilege definition received from the first security token and the creation parameters from the Service Provider the second set of privileges is updated 408 with the new privilege.

Alternatively the second set of privileges can be updated with the new privilege after it was accepted by the second apparatus for programming security tokens and activated, if necessary, after the step of updating.

In one embodiment the first apparatus for programming security tokens and the second apparatus for programming security tokens are connected directly using wireline or wireless connection.

It is within contemplation of the present invention that the apparatus for programming security tokens acts as an interface between the user and the token and when it is mentioned that two apparatuses for programming security tokens are connected it also means that the two security tokens are connected.

With reference to FIG. 5 an apparatus for programming security tokens is shown. As it was explained above the apparatus 500 for programming security tokens is an interface between the user and the security token 520. In case of popular Smartcards that are not equipped with a user interface such apparatus is required to perform the programming.

The apparatus 500 for programming a security token comprises a first interface 502, an authentication section 504 and a memory 506, wherein all these elements are connected to a controller 508. The first interface is used for connecting a security token 520 to the apparatus. Said apparatus 500 further comprises a user interface 510 connected to the authentication section 504. A user of the security token after connection to the apparatus 500 and after authentication is allowed to perform some predefined actions that are presented on the user interface 510. The user interface 510 consists of a display screen and a keyboard. However it is clear for those skilled in the art that other devices performing functions equivalent to those of the keyboard may be successfully used.

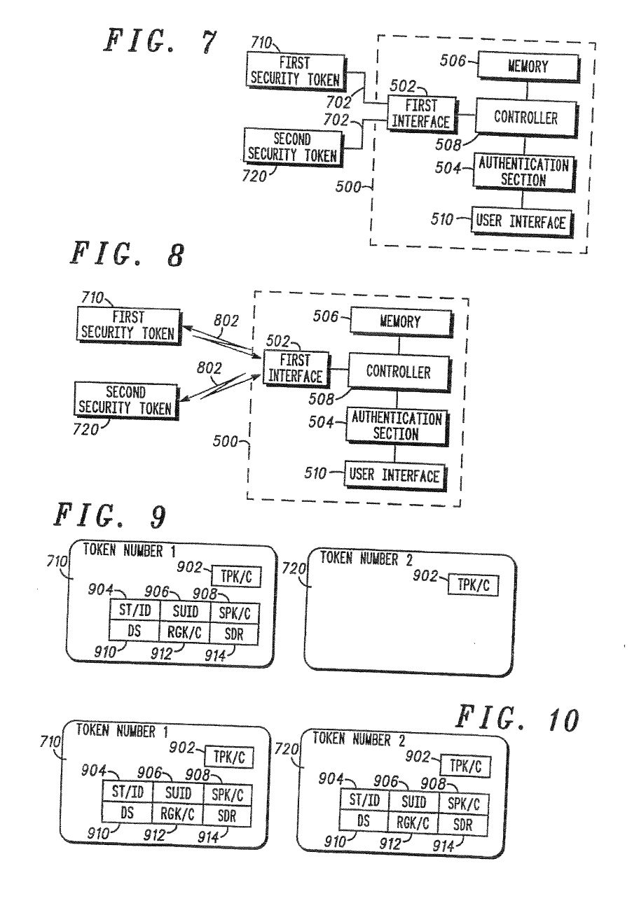

In one embodiment, as illustrated on FIGS. 7 and 8 the apparatus 500 after connection of the first security token 710 and selection of a privilege stores in the memory 506 a file containing definition of the privilege. After connection of the second security token 720 to the first interface 502 of the apparatus 500 the second set of privileges assigned to the second security token is updated with the privilege using definition stored in the memory 506.

As there are contact and contactless security tokens on the market also the first interface 502 may be implemented as contact (using electric connections) 702 or contactless 802 (i.e. wireless).

In an alternative embodiment the apparatus 500 has a communication interface 512 connected to the controller 508. The communication interface 512 allows for connection of the apparatus to a computer and/or communication network.

The access to the computer and/or communication network by means of communication interface 512 may be based on wireline or wireless connection. Some examples of wireless connections are cellular networks (GSM, CDMA, UMTS or other system), TETRA network, Bluetooth, etc.

In one embodiment the first interface 502 and the communication interface 512 are combined into one unit. It is beneficial especially for wireless connections but is possible for wireline connection as well.

In operation the controller 508 derives from the first security token connected to the first interface 502 a first set of privileges and presents the sets of privileges in a textual or graphical form on a user interface 510. The user of the security token selects a privilege that is to be assigned to the second security token and requests transfer of a file containing the definition of the privilege to a second apparatus for programming security tokens. The file is transferred in an encrypted or protected form. The communication interface 512 transmits and receives files defining privileges and the controller 508 encodes and decodes the file. The controller also assures and controls integrity of the file containing definition of the privilege.

As the security token provides access to vital resources all operations performed on the security token must be done only by the authorized person. To meet this security requirement the apparatus 500 has an authentication section 504. Each time when a user of the first security token initiates a process of programming the second security token using data stored on the first security token the authentication section 504 authenticates the person that claims to be a legitimate user of the first security token. The authentication may be performed on a basis of a biometric data or numeric or alphanumeric password string.

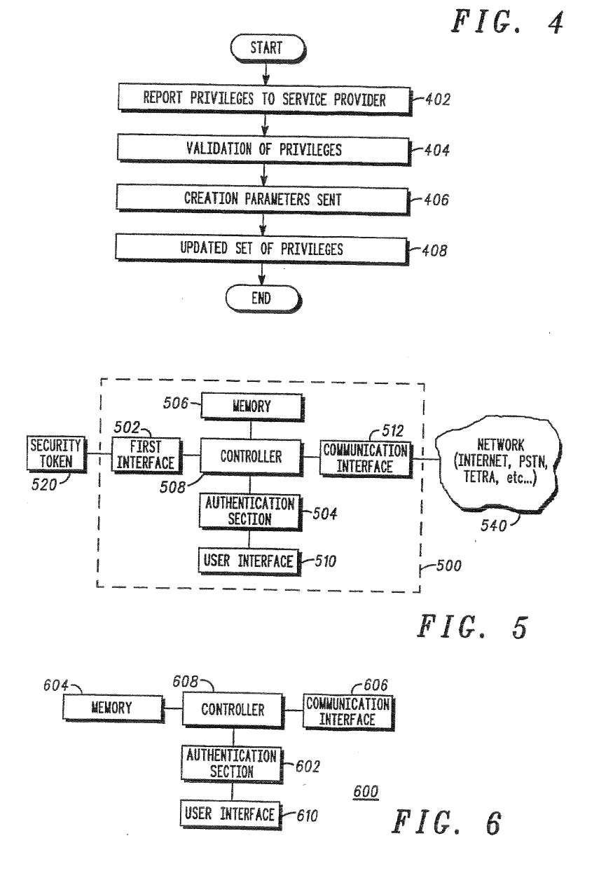

With reference to FIG. 6 one embodiment of an electronic security token 600 is presented. In this embodiment the security token 600 comprises an authentication section 602, a memory 604 and a communication interface 606, and all these elements are connected to a controller 608. Said security token (600) further comprises a user interface 610 connected to the authentication section 602. Security token as described above does not require a separate apparatus for programming as all elements to perform programming according to a method described earlier are implemented in the circuitry of the security token 600.

The memory 604 stores the set of privileges assigned to the security token 600. Functions of the controller 608, the communication interface 606, the user interface 610 and the authentication section 602 are the same as in the apparatus for programming security tokens described earlier.

As the privileges are written in the memory of the security token FIGS. 9 and 10 show the alterations of the memory field structure which is a result of programming of said security token in accordance with an embodiment of the present invention. Referring to FIG. 9 a memory field structure of the first security token 710 and the second security token 720 before transferring of the file with privilege definition is shown. For the sake of clarity in this exemplary embodiment it is assumed that the first security token 710 has already been set up with a set of privileges and one privilege has been selected to be transferred to the second security token 720. Similarly the second security token 720 is shown as not having any privileges assigned. However it is clear for those skilled in the art that this situation would look similar if privileges would be assigned to the second security token. Each security token contains a unique identifier the Token specific Public Key or Certificate (TPK/C) 902.

It is worth to note that names and references 902-914 apply to fields in the memory structure, whose values may be different between tokens.

The privilege assigned to the first security token 710 contains in this embodiment the following fields:

Service Type/ID (ST/ID) 904—identifies what type of service is available for the legitimate user of the security token; for example ATM/bank or credit card/company.

Service User Info/ID (SUID) 906—identifies the legitimate user and allows for its authentication; for example user name/password.

Service Specific Public Key or Certificate (SPK/C) 908—is a cryptographic facility that allows for encryption/decryption of data transferred during transactions performed using the security token.

Delegation Status (DS) 910—identifies current status of the delegation process, for example grantable with activation or creatable without activation.

Receiver's Public Key or Certificate (RGK/C) 912—is a place holder for storing in the first security token 710 the TPK/C of the second security token 720 receiving this privilege after successful privilege transfer. In the second security token 720 this field may receive the TPK/C of the first security token.

Service specific Delegation Restrictions (SDR) 914—restrictions assigned to a privilege by donor and/or SP; for example ATM withdrawal limit up to $200, telephone card limited to local calls only and so on.

After transfer of the file containing definition of the privilege from the first security token 710 to the second security token 720 the memory field structure of the second security token 720 in one embodiment will be as shown on FIG. 10. The fields 904-908 are the same as in the first security token and may be used by the Service Provider (SP) as part of the approval process. After the privilege has been transferred and the specific service ST/ID has activated the privilege, or the privilege is used for the first time, then the SUID field in the second token 720 receives its service specific value.

The field 910 contains Delegation Status (DS). In this field current status of the delegation process is saved. After delegation and before activation it is Pending (if Activation is required). After activation (if required) it is changed to Activated. In the case when Activation is not required the value Activated is written immediately.

After activation Service Provider (SP) may assign a new SPK/C and SUID to the second token. The Service Provider (SP) for this privilege may change the SDR received from the first security token or leave it unchanged.

1. A method of programming an electronic security token comprising:
assigning a set of privileges to a security token, wherein the set of privileges is a second set of privileges assigned to a second security token derived from a first set of privileges assigned to a first security token.

2. The method according to claim 1 comprising the steps of:
selecting at least one privilege derived from the first set of privileges assigned to the first security token;
transferring a file defining the selected at least one privilege from the first security token to the second security token;
updating the second set of privileges on the second security token with the at least one privilege received from the first security token.

3. (canceled)

4. The method according to claim 2, wherein in the step of selecting further comprises privileges not assigned to the first security token, wherein creation of these not assigned privileges is allowed by at least one of the privileges assigned to the first security token.

5. The method according to claim 2 further comprising activating the at least one privilege received by the second security token.

6. The method according to claim 2, further comprising reporting an assignment of the at least one privilege to the second security token to a Service Provider.

7. The method according to claim 2 further comprising removing the at least one privilege from the first security token after it has been assigned to the second security token.

8. The method according to claim 2, wherein the at least one privilege is restricted.

9. The method according to claim 2, wherein the file defining the privilege is transferred by means of secure connection between the first security token and the second security token.

10. (canceled)

11. (canceled)

12. The method according to claim 8, wherein restricted comprises at least one of a) setting a limit for a number of times the privilege can be transferred or used after transfer, and b) setting a time period for which the privilege is assigned to the security token.

13. (canceled)

14. An apparatus for programming a second security token using a first security token, said apparatus comprising a first interface, an authentication section and a memory, wherein all these elements are connected to a controller, said apparatus further comprising a user interface connected to the authentication section.

15. The apparatus according to claim 14 further comprising a communication interface.

16. The apparatus according to claim 15, wherein at least one of a) the first interface and b) the communication interface is adapted to connect with the first or second security token by at least one of a) means of a wired connection and b) means of a wireless connection.

17. (canceled)

18. (canceled)

19. (canceled)

20. (canceled)

21. The apparatus according to claim 14, wherein the controller is adapted to derive a first set of privileges assigned to the first security token, when the first security token is connected to the first interface, and presents the first set of privileges on the user interface.

22. The apparatus according to claim 21, wherein the first set of privileges also contains privileges which are not assigned to the first security token, wherein creation of these not assigned privileges is defined by at least one of the privileges assigned to the first security token.

23. The apparatus according to claim 16, wherein information transferred by means of the connection is encrypted or protected.

24. The apparatus according to claim 15 wherein the communication interface is adapted perform at least one of the following a) transfer a file defining a privilege to be assigned to the second security token and b) receive a file defining a privilege to be assigned to the second security token.

25. (canceled)

26. The apparatus according to claim 14, wherein the user interface is adapted to present the first set of privileges and initiate a transmission of a file defining the privilege from the first security token to the second security token.

27. The apparatus according to claim 14, wherein the authentication section is adapted to authenticate a user of a security token connected to the first interface.

28. (canceled)

29. (canceled)

30. The apparatus according to claim 14, wherein the memory is adapted to store a file defining a privilege.

31. The apparatus according to claim 30 wherein the controller is adapted to transfer the file from the memory to the second security token connected to the first interface and to update the privileges assigned to the second security token with the privilege defined in the file.

32.-41. (canceled)
